(19) United States
(12) Patent Application Publication
(10) Pub. No.: US 2010/0037149 A1
(43) Pub. Date: Feb. 11, 2010

(54) Annotating Media Content Items

(75) Inventor: Taliver Brooks Heath, Mountain View, CA (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 12/186,328

(22) Filed: Aug. 5, 2008

(51) Int. Cl. G06F 3/048

(52) U.S. Cl. 715/753

(57) ABSTRACT

In one general aspect, a media content item is provided to a plurality of users, the media content item having a temporal length. Annotations to the media content item are received from the plurality of users, the annotations each having associated temporal data defining a presentation time during the temporal length. The received annotations are associated with the media content item so that the annotations are presented during the presentation of the media content item at approximately the presentation time during the temporal length.

### FIELD

This disclosure is related to media content items.

### BACKGROUND

Commenting on media content (e.g., audio and video content) is a popular feature of many websites. For example, sites hosting video content often provide a discussion area where viewers may leave comments on the presented video content, as well as comment on the comments made by other users. Sites featuring audio content often provide similar features for audio content.

Such commentary systems can facilitate meaningful discussion of a particular media content item. These commentary systems, however, do not facilitate presentation of comments at particular playback times of the media content.

### SUMMARY

In one general aspect, a media content item is provided to a plurality of users, the media content item having a temporal length. Annotations to the media content item are received from the plurality of users, the annotations each having associated temporal data defining a presentation time during the temporal length. The received annotations are associated with the media content item so that the annotations are presented during the presentation of the media content item at approximately the presentation time during the temporal length.

Implementations may include one or more of the following features. Providing access to the media content item may include streaming the media content item to the plurality of users. The media content item may be a video content item. The annotations may include text annotations. The annotations may include graphical annotations. The annotations may include audio annotations. The associated temporal data defining a presentation time during the temporal length may be specified by a creator of the annotation.

The subject matter of this document relates to the storing of annotations of media content items from many users. The annotations may be presented at specific presentation times during playback of the of the media content item.

Particular implementations of the subject matter described in this specification can be implemented so as to realize one or more of the following optional advantages. One advantage realized is the ability to receive annotations for a media content item along with temporal data defining a presentation time for the received annotations, and to associate the annotations with the media content item such that the received annotations are presented at approximately the defined presentation time during the temporal length of the media content item. Another advantage is the ability to provide annotations associated with a media content item during specified presentation times during the temporal length of the media content item. Another advantage is to filter the annotations associated with a media content item such that only annotations having specified user identifiers are provided. Annotations may be further filtered for content, such as profanity. These optional advantages can be separately realized and need not be present in any particular implementation.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 is an example environment in which a media content item annotation system can be used.

FIG. 2 is an example user interface for presenting and receiving annotations to media content items.

FIG. 3 is a flow diagram of an example process for receiving annotations to a media content item.

FIG. 4 is a flow diagram of an example process for presenting annotations to a media content item.

FIG. 5 is a flow diagram of an example process for presenting annotations to a media content item.

FIG. 6 is a block diagram of an example computer system that can be utilized to implement the systems and methods described herein.

Like reference numbers and designations in the various drawings indicate like elements.

### DETAILED DESCRIPTION

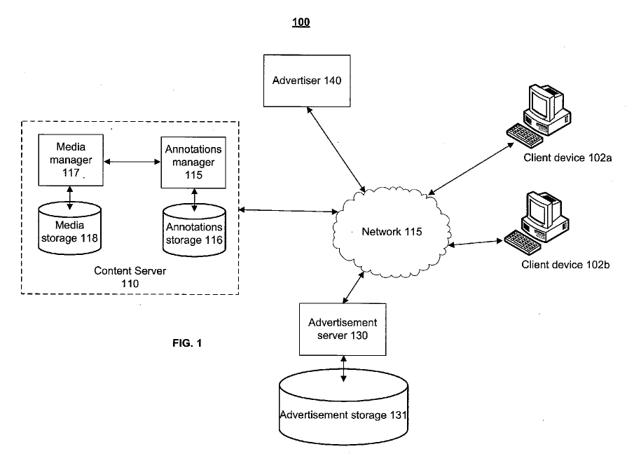

FIG. 1 is an example environment 100 in which a media content item annotation system, e.g., a content server 110, can be used. In some implementations, a media content item annotation system lets viewers add annotations, and/or view previously added annotations to a media content item and define temporal data that defines when the annotation may be displayed. A media content item may include video content items and audio content items. Annotations made to the content item may include one or more of text annotations (e.g., comments or other text), audio annotations (e.g., music or recorded commentary), graphical annotations (e.g., drawings or image files), and video annotations (e.g., video clips).

For example, a video media content item may be viewed over the Internet by a plurality of users. Using an annotation interface, the users can provide annotations to the video while watching the video on a media player. Using the media player, each user may view the video media content item and make comments or annotations to the video media content item. For example, a user may comment on a particular scene, or draw a box on the scene at a particular playback time to point out a favorite moment of the video.

In some implementations, the time at which the annotation is presented during playback of the content item can be implicitly defined. For example, as a video media content item is playing, a user may begin typing text for an annotation at a particular playback time. The particular playback time can be associated with the annotation as temporal data defining a presentation time during playback.

In other implementations, the time at which the annotation is presented during playback of the content item can be explicitly defined. For example, the user may further provide a desired time that specifies when during the video playback the annotation is to be displayed, and, optionally, how long the annotation is to be displayed.

When other users view the video media content item at a later time, the other users are presented with the annotations made by the previous users at the defined presentation time in the video. For example, if a user made a text annotation to the video content item for presentation at the three minute mark, then the annotation may appear to other users at approximately the three minute mark during playback of the video. The later users may additionally add annotations to the video media content item.

In some implementations, the content server 110 may store and provide media content items and associated annotations. Media content items may include video content items, audio content items, and/or a combination of both. The media content items can each have a temporal length, e.g., a length of time that is required to play back the media content item. For example, a three-minute video file has a temporal length of three minutes; a four minute audio file has a temporal length of four minutes, etc.

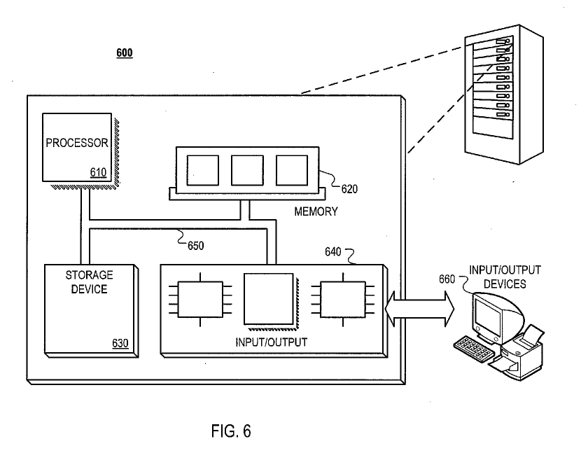

The content server 110 may further provide access to media content items and associated annotations to client devices 102 over a network 115. The network 115 may include a variety of public and private networks such as a public-switched telephone network, a cellular telephone network, and/or the Internet. In some implementations, the content server 110 can provided streamed media data and the association annotations. In other implementations, the audio server 110 can provide media files and associated annotation data by a file download process. Other access techniques can also be used. The content server 110 may be implemented as one or more computer systems 600, as described with respect to FIG. 6, for example.

In some implementations, the content server 110 may include a media manager 117 and a media storage 118. The media manager 117 may store and retrieve media content items from the media storage 118. In operation, the content server 110 may receive requests for media content items from a client device 102a through the network 115. The content server 110, in turn, may pass the received requests to the media manager 117. The media manager 117 may retrieve the requested media content item from the media storage 118, and provide access to the media content item to the client device 102a. For example, the media manager 117 may stream the requested media content item to the client device 102a.

In some implementations, the content server 110 may further include an annotations manager 115 and an annotations storage 116. The annotations manager 15 may store and retrieve annotations from the annotations storage 116. The annotations may be associated with a media content item stored in the media storage 118. In some implementations, each annotation may be stored as row entries in a table associated with the media content item. In other implementations, the annotations may be stored as part of their associated media content item, for example as metadata.

The annotations may include a variety of media types. Examples of annotations include text annotations, audio annotations, graphical annotations, and video annotations. The annotations may further include data identifying an associated media content item, an associated user identifier (e.g., the creator of the annotation), and associated temporal data (e.g., the time in the media content item that the annotation is associated with, such as a presentation time during the temporal length). Additional data that may be associated with the annotation can include a screen resolution and a time duration for the persistence of the annotation display, for example.

The annotations manger 115 may receive requests for annotations from the media manager 117. In some implementations, the request for annotations may include an identifier of the associated media content item, a user identifier identifying an author of the annotation, and temporal data. The annotations manager 115 may then send annotations responsive to the request to the media manger 117.

In some implementations, the request for annotations may include annotation filtering data. The request may specify annotations having certain user identifiers, or only text annotations. A request can include other annotation filtering data, such as content filtering data (e.g., content containing profanity) and time filtering data, etc.

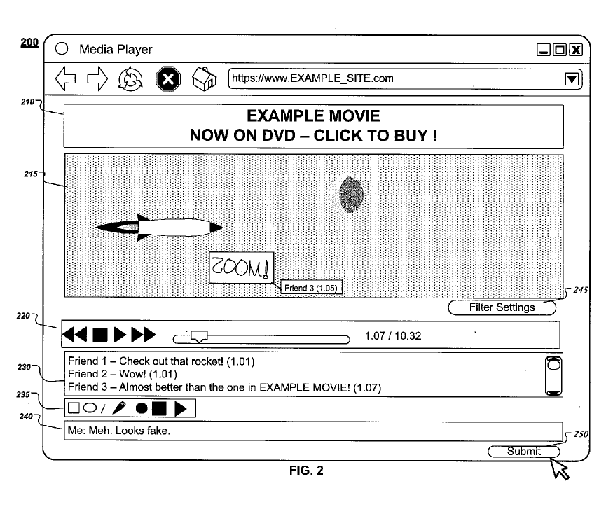

The content server 110 may receive a request for access to a media content item from a viewer and send the request for access to the media manager 117. The media manager 117 may request the associated annotations from the annotations manager 115, and provide the media content item and the responsive annotations associated with the media content item to the client device 102a. The annotations and media content may be provided to be presented on the client device 102a to a viewer through an interface similar to the interface 200 illustrated in FIG. 2, for example. The annotations may be presented during the temporal length of the media content time at approximately the presentation time indicated in the associated temporal data.

In some implementations, the content server 110 may further receive annotations from viewers of the media content items. The content server 110 may, for example, receive the annotations from viewers at a client device 102b through a user interface similar to the user interface 200 illustrated in FIG. 2. In some implementations, the received annotations may include temporal data indicating a presentation time that the annotation is to be presented during the temporal length.

The annotations may further include a user identifier identifying the user or viewer who submitted the annotations. For example, a user may have an account on the content server 110, and may log into the content server 110 by use of a client device 102 and a user identifier. Thereafter, all annotations submitted by the user may be associated with the user identifier. In some implementations, anonymous identifiers can be used for users that do not desire to be identified or users that are not identified, e.g., not logged into an account.

The content server 110 may provide the received annotations to the annotations manager 115. The annotations manager 115 may store the submitted annotation in the annotations storage 116 along with data indicative of the associated media content item.

In some implementations, the content server 110 can communicate with an advertisement server 130. The advertisement server 130 may store one or more advertisements in an advertisement storage 131. The advertisements may have been provided by an advertiser 140, for example. The content server 110 can provide a request for one or more advertisements to be presented with a media content item. The request can, for example, include relevance data, such as, for example, keywords of textual annotations that are to be presented on a client device 102. The advertisement server 130 can, in turn, identify and select advertisements that are determined to be relevant to the relevance data.

In some implementations, the selected advertisements may be provided to the content server 110, and the content server 110 can provide the advertisements to the client device 102 at approximately the same time as the annotation associated with the keywords. The advertisements may be presented in a user interface similar to the user interface 200 illustrated in FIG. 2.

In other implementations, the advertisement server 130 can also receive the associated temporal data of the annotations, and can provide the selected advertisements to the content server 110. The content server 110 can provide the advertisements to the client device 102 for presentation at approximately the same time as the annotation associated with the keywords is presented on the client device. Other temporal advertisement presentation schemes can also be used, e.g., provide the advertisements to the client device 102 and buffering the advertisements locally on the client device 102 for presentation, etc.

In other implementations, the advertisements can be pre-associated with annotations by the advertiser 140. For example, the advertiser 140 may access the annotations stored in the annotations storage 116 to determine which annotations to associate with advertisements. Once an annotation has associated with an advertisement, the advertisement may be stored in the advertisement storage 131 along with an identifier of the associated annotation in the annotations storage 116, for example. In some implementations, the selection of the annotations to associate with advertisements may be done automatically (e.g., using keyword or image based search). In other implementations, the associations may be done manually by viewing the annotations along with the associated media content items and determining appropriate advertisements to associate with the annotations, for example.

The content server 110, the media manager 117, media storage 118, annotations manager 115, annotations storage 116, advertisements server 130 and advertisement storage 131 may be each implemented as a separate computer system, or can be collectively implemented as single computer system. Computer systems may include individual computers, or groups of computers (i.e., server farms). An example computer system 600 is illustrated in FIG. 6., for example.

The annotations manager 115 and the media manager 117 can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium. The annotations manager 115 and the media manager 117 can be implemented separately, or can be implemented as a single software entity.

FIG. 2 is an example user interface 200 for presenting and receiving annotations to media content items. In some implementations, the interface 200 may be implemented at the client device 102a (e.g., through a web browser) and may send and receive data to and from the content server 110. In other implementations, the interface 200 may also be implemented as a stand alone application such as a media player, for example.

The user interface 200 includes a media display window 215. The media display window 215 may display any video media content associated with media content item during playback. As illustrated in the example shown in FIG. 2, the media display window 215 is displaying a video media content item featuring a rocket in space. The video media may be provided by the media manager 117 of the content server 110, for example.

In other implementations, the media display window 215 can display video media content associated with audio content, e.g., a spectral field generated in response to the playback of a song, for example.

The user interface 200 may further include a media control tools 220. The media control tools include various controls for controlling the playback of the media content item. The controls may include fast forward, rewind, play, stop, etc. The media controls tools 220 may further include a progress bar showing the current presentation time of the media content item relative to the temporal length of the media content item. For example, the progress bar illustrated in the example shows a current presentation time of 1 minute and 7 seconds in a total temporal length of 10 minutes and 32 seconds.

In some implementations, the media display window 215 may further display graphical annotations made by previous viewers. As illustrated, there is a graphical annotation in the media display window 215 of the phrase “Zoom!.” In some implementations, the annotation can include a user identifier of a user that created the annotation. For example, indicated by the data displayed next to the annotation, the annotation was made by a previous viewer associated with the user identifier “Friend 3.” The annotation also includes the presentation time at which the annotation was presented, e.g., 1.05, indicating 1 minute and 5 seconds. The previous viewer may have made the graphical annotation to the media content item using the drawing tools illustrated in the drawing and sound tools 235, for example. Alternatively, the viewer may have selected or uploaded a previously made image or graphic to create the graphical annotation.

The user interface 200 further includes a text annotation viewing window 230. The text annotations viewing window may display text annotations of previous viewers at approximately the presentation time defined by the temporal data associated with the annotation. A shown, there are three text annotations displayed in the text annotation viewing window 230. Next to each of the displayed annotations is a time in parenthesis indicating the time relative to the media content item that the annotations were presented during the temporal length. The text annotations are displayed in the text annotation window 230 at approximately the presentation time defined by the temporal data associated with the annotation. The annotations may be provided by the annotations manager 115 of the content server 110, for example.

Because a media content item may have a large number of annotations, a viewer may wish to filter or reduce the number of annotations that are displayed. Thus, in some implementations, displayed annotations may be filtered using the filter settings button 245. In some implementations, a pop-up window can appear in response to the selection of the filter settings button 245 and present a filtering options menu. Using the filtering options menu, the viewer may select to only see annotations made by users with user identifiers matching users in the viewers contact list or friends/buddies list; or may manual select which users to see annotations from. In other implementations, the user may chose to exclude the annotations from certain users using an ignore list, for example. In other implementations, the user may chose to filter annotations have profanity, or may chose to filter some or all comments for a specified time period during the temporal length of the media content item. In other implementations, the user may choose to filer annotations by type (e.g., only display text annotations).

In some implementations, the annotation filtering may be done at the content server 110, by the annotations manager 115, for example. In other implementations, the filtering may be done at the client device 102a.

In some implementations, the user interface 200 further includes a drawing and sounds tools 235. A viewer may use the tools to create a graphical annotation on the media display window 215, for example. The viewer may further make an audio annotation using an attached microphone, or by uploading or selecting a prerecorded sound file.

The user interface 200 may further include a text annotations submission field 240. The text annotations submission field 240 may receive text annotations to associate with a media content item at the time the text annotation is submitted. As shown, the viewer has entered text to create an annotation. The entered text may be submitted as an annotation by selecting or clicking on the submit button 250. Any generated annotations are submitted to the annotations manager 115 of the content storage 110, where they are stored in the annotations storage 116 along with temporal data identifying when the annotations are to be presented, user identification data identifying the user who made the annotations, and data identifying the associated media content item, for example.

In some implementations, the temporal data can be set to the time in the temporal length at which the user began entering the annotation, e.g., when a user paused the video and began entering data, or when a user began typing data in the text annotation submission field.

The temporal data can also be set by the user by specifying a presentation time during the temporal length of the media content item. For example, the user “Friend 3” may specify that the “Zoom!” annotation appear at the presentation time 1 minute and 5 seconds. The user may further specify a duration for the annotation or specify a presentation time during the temporal length of the media content item when the annotation may be removed. For example, the user “Friend 3” may specify that the “Zoom!” annotation disappear at the presentation time 1 minute and 20 seconds, or alternatively have a duration of 15 seconds.

The user interface 200 may further include an advertisement display window 210. The advertisement display window may display one or more advertisements with one or more of the displayed annotations. The advertisements may be provided by the advertisement server 130. The advertisement may be determined based on keywords found in one or more of the annotations, or may have been manually determined by an advertiser 140 as described with respect to FIG. 1, for example. In some implementations, the advertisements may be displayed at approximately the same time as a relevant annotation, but may persist in the advertisement display window 210 longer than the annotation to allow the viewer to perceive them. As shown, an advertisement for “EXAMPLE MOVIE” is shown corresponding to “EXAMPLE MOVIE” being discussed in the annotations.

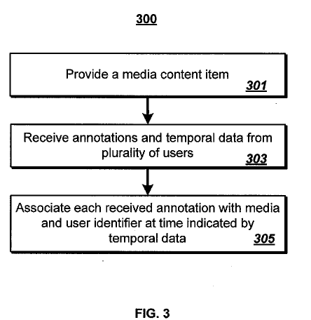

FIG. 3 is a flow diagram of an example process 300 for receiving annotations to a media content item. The process 300 can, for example, be implemented in the content server 110 of FIG. 1.

A media content item is provided for a plurality of users (301). The media content item may be provided by the media manager 117 of the content server 110. For example, the media content item may be streamed to users at client devices 102b.

Annotations are received from one or more of the users (303). The annotations may be received by the annotations manager 115 of the content server 110. The annotations include temporal data defining a presentation time during the temporal length of a media content item, and a user identifier identifying the user that made the annotation, for example. The annotations may have been made by users at the client device 102b using a user interface similar to the user interface 200 described in FIG. 2, for example.

The annotations are associated with the media content item (305). The annotations may be associated with the media content item by the annotations manager 115 of the content server 110 by storing the annotations in the annotations storage 116 along with the user identifier, temporal data defining a presentation time, and an identifier of the associated media item. The annotations are associated with the media content item in such a way that when the media content item is viewed, the received annotations will be presented during the presentation of the media content item at approximately the presentation time during the temporal length.

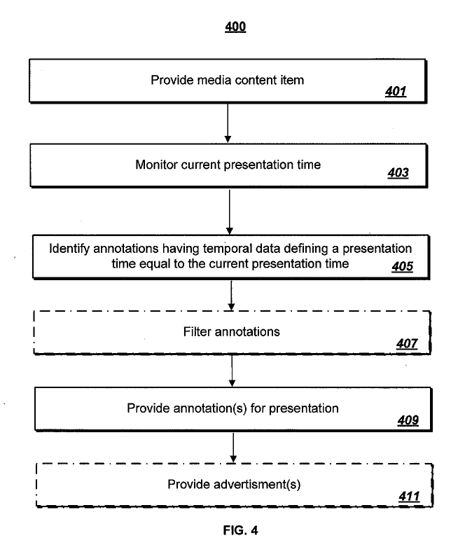

FIG. 4 is a flow diagram of an example process 400 for presenting annotations to a media content item. The process 400 can, for example, be implemented in the content server 110 and the advertisement server 130 of FIG. 1.

A media content item is provided (401). The media content item may be provided by the media manager 117 of the content server 110. For example, the media content item may be streamed to users at one or more client devices 102a and 102b.

A current presentation time of the media content item temporal length is monitored (403). The current presentation time of the media content item may be monitored by media manager 117 of the content server 110, for example.

Annotations having temporal data defining a presentation time equal to the current presentation time are identified (405). The annotations having a presentation time equal to the current presentation time may be identified by the annotations manager 115 of the content server 110. The annotations manager 115 may query the annotation storage 116 for annotations having temporal data specifying the current presentation time or that are close to the current presentation time.

The responsive annotations are retrieved and optionally filtered (407). The annotations may be retrieved by the annotations manager 115, for example. The retrieved annotations may be filtered to include only annotations made by users approved by the viewer, or alternatively, to remove annotations made by users specified by the viewer. The annotations may be further filtered to exclude certain annotation types or to remove annotations having profanity, for example. The annotations may be filtered by the annotations manager 115 of the content server 110. Alternatively, the annotations may be transmitted to the client device 102a, and filtered at the client device 102a, for example

The annotations are provided for presentation (409). Where the annotation filtering is done at the content server 110, the filtered annotations are provided to the client device 102a and presented to the viewer using a user interface similar to the user interface 200 illustrated in FIG. 2, for example. Where the annotation filtering was done by the client device 102a, the annotations are similarly presented to the viewer. The annotations are presented at approximately the presentation time specified in the temporal data associated with the annotations during the temporal length of the media content item.

Advertisements relevant to the annotations may be optionally provided (411). Advertisements may be retrieved from the advertisement storage 131 by the advertisement server 130. The retrieved advertisements are presented to the client device 102a and displayed to the user in a user interface similar to the user interface 200 illustrated in FIG. 2, for example. In some implementations, the advertisements can be displayed at approximately the same presentation time as the relevant annotations.

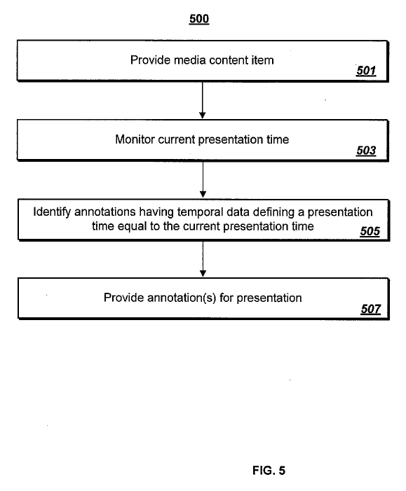

FIG. 5 is a flow diagram of an example process 500 for presenting annotations to a media content item. The process 300 can, for example, be implemented in the content server 110 of FIG. 1.

A media content item is provided (501). The media content item may be provided by the media manager 117 of the content server 110, for example. The media content item may be provided to a client device 102a for presentation to a viewer by streaming the media content item to the client device 102a. The client device 102a may receive the streaming media content item and play or present the media content item to a viewer through a user interface similar to the user interface 200 illustrated in FIG. 2, for example.

The media content item has a temporal length and one or more associated annotations. The annotations may include text, graphic, audio, and video annotations, for example. Each annotation may have an associated user identifier identifying the user that made the annotation. Each annotation may further have temporal data describing a presentation time in the temporal length of the media content item.

A current presentation time of the media content item temporal length is monitored (503). The current presentation time of the media content item may be monitored by media manager 117 of the content server 110, for example.

Annotations having a temporal data defining a presentation time equal to the current presentation time are identified (505). The annotations may be identified in the annotations store 116 by the annotations manager 115 of the content server 110, for example. The current presentation time may refer to the time in the temporal length of the media content item being presented.

The identified annotations are provided for presentation at approximately the current presentation time (507). The annotations may be provided to the client device 102a from the annotations manager of the content server 110, for example. The identified annotations may be first provided to a buffer, to avoid network congestions, for example. The annotations may be then provided to the client device 102a from the buffer. The buffer may be part of the content server 110, for example.

FIG. 6 is a block diagram of an example computer system 600 that can be utilized to implement the systems and methods described herein. For example, the content server 110, media manager 117, the annotations manager 115, the media storage 118, the annotations storage 116, the advertisement server 130, the advertisement storage 131, and each of client devices 102a and 102b may each be implemented using the system 600.

The system 600 includes a processor 610, a memory 620, a storage device 630, and an input/output device 640. Each of the components 610, 620, 630, and 640 can, for example, be interconnected using a system bus 650. The processor 610 is capable of processing instructions for execution within the system 600. In one implementation, the processor 610 is a single-threaded processor. In another implementation, the processor 610 is a multi-threaded processor. The processor 610 is capable of processing instructions stored in the memory 620 or on the storage device 630.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 can, for example, include a hard disk device, an optical disk device, or some other large capacity storage device.

The input/output device 640 provides input/output operations for the system 600. In one implementation, the input/output device 640 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 660.

The apparatus, methods, flow diagrams, and structure block diagrams described in this patent document may be implemented in computer processing systems including program code comprising program instructions that are executable by the computer processing system. Other implementations may also be used. Additionally, the flow diagrams and structure block diagrams described in this patent document, which describe particular methods and/or corresponding acts in support of steps and corresponding functions in support of disclosed structural means, may also be utilized to implement corresponding software structures and algorithms, and equivalents thereof.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A computer-implemented method comprising:
providing a media content item to a plurality of users, the media content item having a temporal length;
receiving annotations to the media content item from the plurality of users, the annotations each having associated temporal data defining a presentation time during the temporal length; and
associating the received annotations with the media content item so that the annotations are presented during the presentation of the media content item at approximately the presentation time during the temporal length.

2. The method of claim 1, wherein providing access to the media content item comprises streaming the media content item to the plurality of users.

3. The method of claim 1, wherein the media content item is a video content item.

4. The method of claim 1, wherein the annotations comprise text annotations.

5. The method of claim 1, wherein the annotation comprise graphical annotations.

6. The method of claim 1, wherein the annotations comprise audio annotations.

7. The method of claim 1, wherein the associated temporal data defining a presentation time during the temporal length is specified by a creator of the annotation.

8. The method of claim 1, wherein the associated temporal data defining a presentation time during the temporal length is the time during the temporal length when the annotation associated with the temporal data is created.

9. A computer-implemented method comprising:
providing a media content item for presentation on a client device, the media content item having a temporal length and associated with a plurality of annotations from a plurality of users, each annotation having an associated user identifier and associated temporal data;
monitoring a current presentation time of the temporal length;
identifying annotations having temporal data defining a presentation time equal to the current presentation time; and
providing the identified annotations for presentation with the media content item at approximately the current presentation time during the temporal length.

10. The method of claim 9, wherein providing the media content item comprises streaming the media content item.

11. The method of claim 9, wherein the media content item comprises a video content item.

12. The method of claim 9, wherein the annotation is a text annotation.

13. The method of claim 9, wherein the annotation is a graphical annotation.

14. The method of claim 9, further comprising:
filtering the identified annotations; and
only providing the filtered identified annotations for presentation with the media content item at approximately the current presentation time during the temporal length.

15. The method of claim 14, wherein filtering the identified annotations comprises filtering the identified annotations by user identifiers associated with the identified annotations.

16. The method of claim 15, wherein filtering the identified annotations by user identifier comprises retrieving a list of users and filtering the identified annotations using the retrieved list of users.

17. The method of claim 15, wherein filtering the identified annotations comprises filtering the identified annotations by content.

18. The method of claim 15, wherein filtering the identified annotations comprises filtering identified annotations having temporal data defining a presentation time falling into a specified time period.

19. The method of claim 9, further comprising identifying an advertisement related to one or more of the identified annotations, and presenting the advertisement at approximately the presentation time of the related annotation.

20. The method of claim 19, wherein the identified annotations comprise text annotations, and identifying an advertisement related to one or more of the identified annotations comprises identifying keywords associated with advertisements in the identified annotations.

21. A computer-implemented method, comprising:
receiving at a client device a media content item having a temporal length;
receiving at the client device annotations to the media content item, the annotations each having associated temporal data defining a presentation time during the temporal length;
presenting the media content item at the client device; and
presenting the annotations at the client device at approximately the presentation time during the temporal length.

22. The method of claim 21, wherein the media content item is a video content item.

23. The method of claim 21, further comprising:
filtering the received annotations; and
only presenting the filtered annotations at the client device at approximately the presentation time during the temporal length.

24. The method of claim 21, further comprising identifying an advertisement related to one or more of the received annotations, and presenting the advertisement at the client device at approximately the presentation time during the temporal length of the related annotation.
